(19) United States
(12) Patent Application Publication
(10) Pub. No.: US 2002/0070516 A1
(43) Pub. Date: Jun. 13, 2002

(54) Shopping cart immobilizing cradle

(76) Inventors: Edward Franklin Haas, Albuquerque, NM (US); Amy Elizabeth Haas, Albuquerque, NM (US)

Correspondence Address: Edward F. Haas, 840 Diana Place N.E., Albuquerque, NM, 87123, US

(21) Appl. No.: 09/735,032

(22) Filed: Dec. 12, 2000

(51) Int. Cl. B62D 39/00

(52) U.S. Cl. 280/33.992

(57) ABSTRACT

A shopping cart immobilizing cradle device, as shown in FIG. (1), in the preferred embodiment having a base of the ramp (3) which inclines upward to the top of the ramp (9) and having tapering inwards ramp walls (4) on both sides of the entire ramp. The top of the ramp (9) feeds into cradle (2) having parallel cradle walls (5) on both sides of the cradle (2). Nylon retrieval strap (11) is permanently attached to the device by friction after being pressed into slot (7) while plastic hook (12) is permanently attached to the loose end of the strap (11). Foot insertion slot (6) has a back wall (10) to stop the toe of the foot. Device bottom (1) is placed on top of the standing surface by lowering the device by means of the retrieval strap (11). The base of the ramp (3) is properly positioned when centered just in front of either front castor wheel of the shopping cart. The user places the front of their foot into insertion slot (6) until the toe of the shoe touches the back wall (10). The user grasps the front top front rail of the shopping cart and deliberately pulls the front wheel up to the top of the ramp (9) until the wheel drops into cradle (2). The shopping cart is now completely immobilized for the safe unloading of its contents.

### BACKGROUND OF THE INVENTION

The surfaces of all properly engineered parking lots at stores where people shop are constructed with some degree of grade. This sloping of the parking lot surface promotes “runoff,” where gravity forces accumulating surface liquids such as rainwater to flow to a desired point for collection or direct discharge. In this way, the sloping of the parking surface prevents the undesired excess accumulation of water known as “pooling” or more commonly referred to as “puddles.”

Many people take excellent care of their vehicles, attempting to preserve their considerable investment as much as possible. These people are too conscientious to restrain a heavy shopping cart (for the purpose of unloading) by placing the cart up against the shiny paint job or chrome trim of their vehicle, possibly scratching or even denting their vehicles delicate surfaces.

The typical shopping/grocery cart is a wheeled item-transfer device, with fully pivoting front wheels, commonly called castors, that allows for the easy steerage of the cart. This classic cart design makes it inherently dangerous when attempting to use a cart on any sloped surface. Any measurable surface slope can cause the unrestrained castor front wheels, by means of gravitational force, to parallel align with each other and face the downhill slope. This often can cause even an empty cart to begin rolling, while a loaded one will very quickly gain speed, becoming a heavy rolling projectile that can possibly strike and even severely damage other parked vehicles.

The sloping of the parking lot combines with this inherit dangerous design of the shopping cart to create a serious problem for the customer who attempts to release hold of the cart to unload it. After arriving at their vehicle with the loaded cart, a person must open their vehicle trunk or side door while still preventing the cart from moving. Actually unloading the cart is much more difficult, as the customer grapples with transferring groceries (and/or children) from the cart to the vehicle, all while trying to keep the cart from denting or scratching their own car or from even rolling away.

### BACKGROUND DISCUSSION OF PRIOR ART

Although the prior patents, appended with applicant's invention disclosure statement, disclose various ways to restrain or stop one or more of the wheels on a shopping cart, none of them individually or in combinations discloses or suggests applicant's shopping cart immobilizing cradle device detailed below. Known prior patents disclose numerous ways to brake, bind, or otherwise restrict the wheels of a shopping cart. Some inventions have devised ways to prevent cart theft by locking the front castor in a turned position. A few devices are intended to restrict or prevent one wheel from turning, in the attempt to keep the unattended shopping cart from moving.

Known prior patents fail to disclose a desire to provide a device that guides the selected front wheel of a shopping cart up to the top of an inclined ramp, where this wheel then drops into an immobilizing cradle and prevents the entire cart from accidentally moving in any direction. Providing a device that guides the castor front wheel of a shopping cart up to the top of a walled ramp to then drop into an immobilizing cradle is apparently unknown. Found prior patents are all for devices that are installed upon the cart itself, requiring the cart manufacturer or current cart owner to purchase and install each device. Since almost no locking or restraining devices can be found on any of the shopping carts in use today, a user providing a temporary means for securely immobilizing their own shopping cart is apparently unknown. Another apparently unknown element is a nylon device retrieval strap, whereby a physically impaired person can retrieve their cart-immobilizing device without having to stoop or even bend over. Providing a retrieval strap for the convenience of healthy persons or as a necessity for the physically impaired, in order to retrieve the cart immobilizing device without stooping or bending over, is apparently unknown. A still further apparently unknown element is the provision of a foot insertion indentation to prevent the cart immobilizing device from sliding forward as the front wheel of the cart is pulled up the ramp and into the cradle. The provision of a foot placement slot to prevent the device from sliding forward as the front wheel of a shopping cart exerts sideways pressure from being pulled up the ramp towards the user is apparently unknown.

### OBJECTS AND ADVANTAGES

All these prior patents lack important advantages of applicant's invention: The provision of a device that guides the selected castor front wheel of a shopping cart up a walled ramp to the top, where the wheel then drops into a cradle to safely immobilize the entire cart. Many prior patents offer various mechanisms intended to grasp or clamp the wheel in a stopped position. The heavier the cart is loaded, the more likely these compression devices are to slip or even fail. The greater the cart weight bearing down on applicant's invention, the tighter the entire device is pressed against the parking lot surface to even further insure against the slightest slippage. A further advantage is the provision of a device that the cart user can own and carry along whenever they go shopping, insuring they don't have to rely on any store for equipping their shopping carts with reliable immobilizing systems. A still further advantage of applicant's invention is the device retrieval strap, which allows for easy placement and retrieval, without bending over or stooping down. Yet another advantage of applicant's invention is the provision of a foot insertion slot to prevent the device from sliding forward as the front wheel of a shopping cart exerts sideways pressure from being pulled up the ramp towards the user.

Accordingly, it is an object of the present invention to provide an affordable and durable sufficiently rigid plastic device, able to safely immobilize any reasonably loaded shopping cart on any reasonably sloped and relatively flat standing surface.

Another object of the present invention is to provide an inclined and walled ramp to transfer and guide the selected front castor wheel up from the parking lot surface and into the capturing cradle, which locks that wheel into place and immobilizes the entire shopping cart.

Another specific object is to provide a foot insertion slot to prevent the device from sliding forward as the front wheel of a shopping cart exerts sideways pressure from being pulled up the ramp towards the user.

A further object of the invention is to provide a device retrieval strap to slowly lower the device to the parking surface and to then raise it back up again after usage. This nylon strap is a matter of convenience for healthy shoppers and a necessity for the physically impaired, as it eliminates the need of bending over or stooping down.

A still further object of the invention is to provide a hook on the loose end of the retrieval strap to place over the top rail of the shopping cart, preventing the retrieval strap from falling down to the standing surface.

These and other objects and advantages will be better understood and appreciated from a consideration of the drawings and ensuing description.

### SUMMARY OF PRESENT INVENTION

The present invention is a walled inclined ramp with the perpendicular walls being farther apart at the base of the ramp and tapering closer together toward the top of the ramp. The base of the ramp actually touches the parking lot surface, allowing the easy transfer of either castor front wheel from the parking lot surface to the ramp surface. The perpendicular walls beginning on both sides of the base of the ramp are significantly further apart than the width of the cart front wheel, eliminating the need for precise device placement. The front wheels of a standard shopping cart are mounted on castors, allowing them to swing freely in a complete circular motion. As the castor front wheel is rolled up the ramp, the perpendicular walls force the pivoting wheel to stay on the ramp. Both ramp walls taper closer together towards the top of the ramp, and the swinging wheel is always forced to move back toward the middle of the narrowing ramp after bumping into either wall. At the very top of the ramp the perpendicular walls are only sufficiently further apart than the width of the standard shopping cart wheel, to allow for the passage of the wheel into the cradle. The perpendicular parallel walls of the cradle are a continuation of the perpendicular walls at the top of the ramp and maintain the same width. The radius of the cradle is the same radius as the wheel on a standard shopping cart to provide the snugness required for totally immobilizing the cart. The tapering wall ramp design best serves to guide the selected pivoting front wheel of the shopping cart up from the parking lot surface and into the close confines of the capturing cradle, thereby immobilizing the entire cart for the purpose of unloading.

The device is constructed by forcing molten polypropylene inside a custom designed pressure mold that is then allowed to cool off, forming the sufficiently rigid plastic device. The finished product has a rough texture generally flat bottom, which helps to prevent it from sliding on any smooth parking lot surface. The ramp walls on either side of the selected pivoting wheel keep it relatively straight as it rolls up the narrowing ramp. At the high point of the ramp, the wheel suddenly drops into the cradle, locking the wheel into place and preventing any further cart movement. On the side opposite from the ramp base the invention has a foot indentation into which the toe of one shoe is inserted. This foot placement insures that the device doesn't slide forward towards the user as the loaded cart exerts sideways pressure created by the pivoting wheel being pulled up the ramp towards the cradle. One end of the retrieval strap is permanently attached to the device and has a proper overall length to reach sufficiently higher than the top rail of a standard shopping cart. The nylon retrieval strap is permanently attached to the invention at the point of weight balance such that the bottom of the device hangs parallel with the parking surface as the strap is slowly lowered. The nylon straps' loose end has a permanently attached open plastic hook to hang over the cart top rail to prevent the strap from falling to the parking lot surface. The device is prepared for use by slowly lowering it to the parking lot surface by means of the retrieval strap. This nylon strap can be slowly twisted to easily guide the base of the hanging walled ramp into the proper position of just in front of either front wheel before the device is set completely down. The plastic hook on the loose end of the nylon strap is then placed over the top rail. The preferred toe is now placed into the foot indentation, the user firmly grabs the front top rail of the shopping cart with both hands, and the loaded cart is then pulled towards the user up the inclined ramp and into the cradle. After the cart has been unloaded, the front wheel is removed from the cradle by slightly picking up and gently pushing back on the front of the empty cart, and the strap then allows a person to retrieve the device without stooping or even bending over. This is especially helpful for people with physical ailments, limitations, or disabilities.

### BRIEF DESCRIPTION OF THE DRAWINGS

FIG. 1 is a top plan view of the shopping cart immobilizing cradle device, constructed in accordance with the present invention.

FIG. 2 is a cross-sectional view of the shopping cart immobilizing cradle device taken along the line 8-8 in FIG. 1.

FIG. 3 is a front view of the shopping cart immobilizing cradle device taken from the point of the ramps' base.

FIG. 4 is a rear view of the shopping cart immobilizing cradle device taken from the point of the foot insertion indentation.

### DETAILED DESCRIPTION OF THE PREFERRED EMBODIMENT

Referring now to the drawings, there is shown a preferred embodiment for the shopping cart immobilizing cradle device of this invention. The shopping cart immobilizing cradle is described for holding a loaded shopping cart free from any movement while it is sitting unrestrained on a sloped parking lot surface and being unloaded. The shopping cart immobilizing cradle of the present invention is particularly adapted for use with all standard shopping carts, regardless of the weight of their load or the degree of surface slope that the device is being used upon. The shopping cart immobilizing cradle is characterized by an ability to grip the parking lot surface with ever greater force as the load weight of the cart is increased.

Referring to FIG. 1 of the drawings, there is shown a top plan view of a shopping cart immobilizing cradle device of the present invention. The base of the ramp 3 transfers the selected front castor wheel of the shopping cart onto the ramp surface from the parking lot surface that the device rests upon. Ramp walls 4 keep the pivoting front wheel on the ramp surface, while guiding the swinging wheel to the narrowed top of the ramp 9, where the wheel then drops into cradle 2. Cradle walls 5 lock the wheel in place by preventing the wheel from pivoting or sliding off either side of the cradle. The nylon retrieval strap is inserted by mechanical means of pressure into slot 7, where the strap permanently remains by means of compressed friction. The toe of the users' foot is placed on top of the foot indentation 6 and the foot is slid forward until the toe reaches the foot indentation back wall 10.

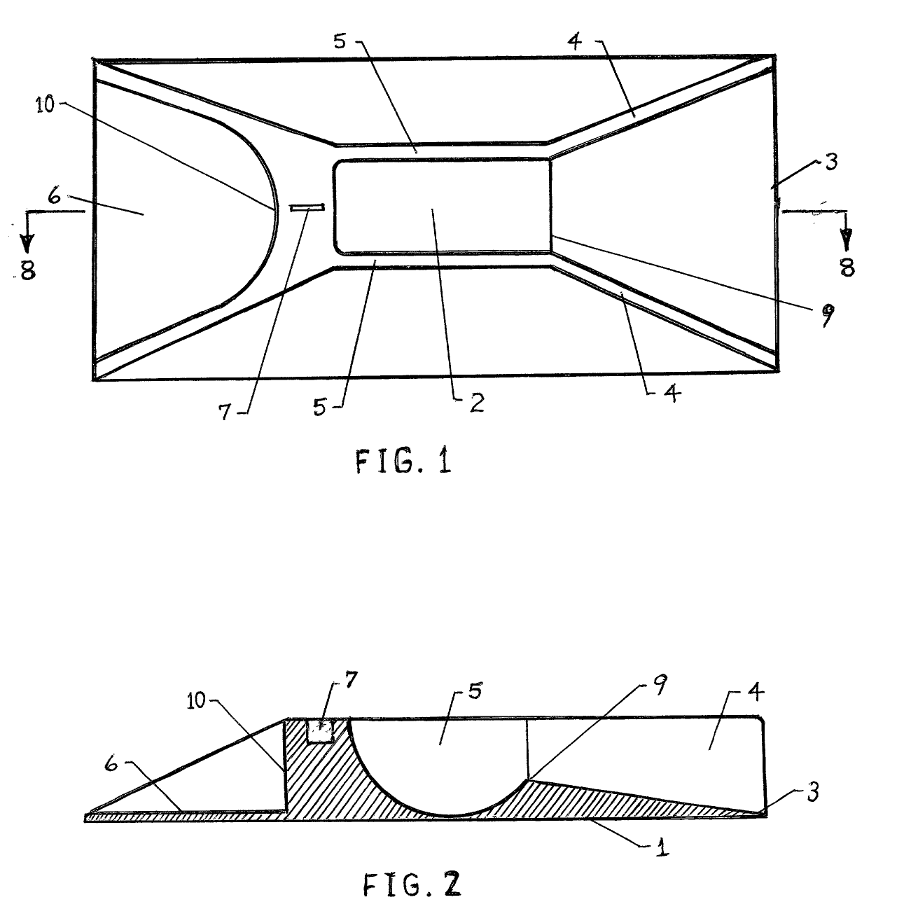

FIG. 2 shows a cross-sectional view where bottom 1 is shown in proper relationship with the base of the ramp 3 leading to the top of the ramp 9 at the front of the device and the foot indentation 6 located at the rear.

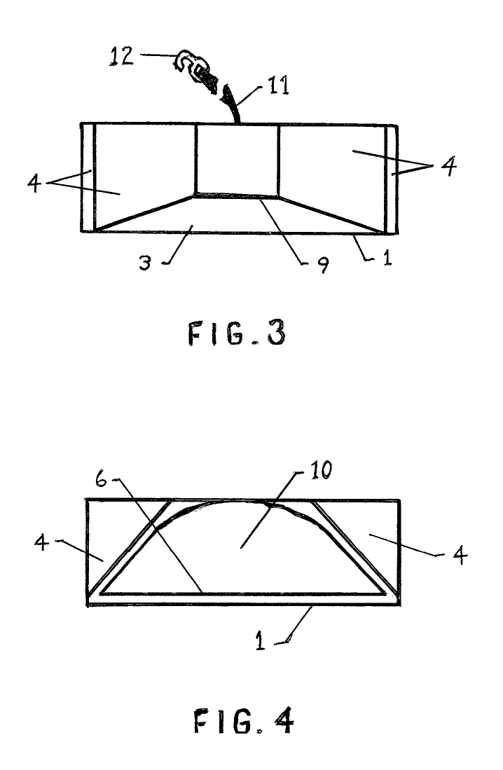

FIG. 3 shows a front view where base of the ramp 3 transfers the front castor wheel of the shopping cart up to top of the ramp 9, guided along the way by ramp walls 4. FIG. 3 also shows retrieval strap 11 properly and permanently inserted into the device, with hook 12 permanently attached to the loose end of strap 11.

FIG. 4 shows a rear view where the bottom 1 is seen in proper relationship with foot indentation 6 and the foot indentation back wall 10.

### Operation

To prepare for use, the shopping cart immobilizing cradle device is removed from its storage location, generally in the vehicle trunk of the user. The retrieval strap is removed from the cradle slot where it is tucked after each use. Grasping the approximate middle of the strap between the thumb and forefinger, the device is lowered by releasing finger pressure on the strap and letting the device gently slide towards the parking lot surface. The strap is turned slightly until the ramp base pivots around to be approximately centered with and slightly touching the front castor wheel furthest down the surface slope. The plastic hook on the free end of the retrieval strap is now placed over the top rail of the cart to prevent the strap from falling to the parking surface. The preferred toe is placed all the way into the foot receptacle indentation and the foot is pressed downward as both of the users' hands are placed on the top rail of the cart front. The shopping cart is now deliberately pulled up the inclined ramp toward the user until the wheel drops into the capturing cradle. The cart can now be safely unloaded, without fear of it rolling around to damage the users' or any other vehicle. After the cart has been unloaded, the front wheel is removed from the cradle by slightly picking up and gently pushing back on the front top rail of the empty cart, and the strap then allows a person to retrieve the device without either stooping or bending over. The retrieval strap with hook is loosely coiled and tucked into the cradle slot, and the device is now ready to be returned to storage.

The same operational procedure is followed when the shopping cart owner permanently installs the immobilizing cradle device on each shopping cart. However, the loose end of the nylon retrieval strap would have no hook but instead be permanently attached to the front top rail of the shopping cart. This permanent strap attachment keeps it from falling while also preventing theft of the device. Storage of the device would be inside the shopping cart basket.

### Conclusions, Ramifications, and Scope of the Invention

From the foregoing description, those skilled in the art would appreciate that all the objects of the present invention are realized. A shopping cart immobilizing cradle device has been shown and described to provide a sure way of immobilizing a shopping cart containing any weight load on any parking surface with any degree of slope for the purpose of safely unloading the cart contents.

While my above descriptions contain much specificity, these should not be construed as limitations of the scope of the invention, but rather as an exemplification of one preferred embodiment thereof. Many other variations are possible. For example, although the preferred embodiment of the device is formed by the method of molten polypropylene being forced by pressure into a custom designed mold to then cool and later be removed, any materials that could be properly formed by any means to accomplish any similar shape and having any similar function could instead be used without departing from the spirit of the invention.

One skilled in the art would realize that although the tapering walls on both sides of the ramp of the preferred embodiment are perpendicular and basically straight, the walls could employ any degree of curvature in any way without departing from the spirit of the invention. Similarly, although the cradle of the preferred embodiment has the same radius as the standard wheel of a shopping cart, a larger or smaller cradle radius would not depart from the spirit of the invention. Similarly, although the width of the cradle of the preferred embodiment is only slightly wider than the width of the standard shopping cart wheel, it could be significantly wider without departing from the spirit of the invention.

Those familiar with the art will appreciate that although the retrieval strap of the preferred embodiment is constructed of thin 1″ wide standard nylon strapping, any flexible material could be used to place and retrieve the device without departing from the spirit of the invention. Similarly, although the attached hook on the free end of the retrieval strap of the preferred embodiment is made of plastic, any suitable material or design could be used to keep the strap from falling. Additionally, when commercial applications call for secure device protection, the loose end of the retrieval strap is permanently attached to the front top rail of the shopping cart to prevent theft.

Those familiar with the art are aware that the retrieval strap has no operational function but instead is a matter for convenient placement and retrieval of the device: Similarly, with commercial applications the retrieval strap acts as a security tether to prevent device theft.

One skilled in the art would realize although the toe of the foot is provided for and employed to absolutely guarantee the device does not slide upon its resting surface, the use of the foot is not essential to the basic design and operation of the device. Similarly, any ramped device discharging into any basic cradle could be used without departing from the spirit of the invention.

Those familiar with the art would realize although the flat bottom of the preferred embodiment has a rough finish, any applied gripping materials or cast finish other than completely smooth that would serve to prevent any slippage of the device does not depart from the spirit of the invention.

Having described the invention in detail, those skilled in the art will appreciate that modifications may be made to the invention without departing from the spirit. Accordingly, the scope of the invention should not be determined by the embodiment illustrated, but by the appended claims and their equivalents.

What is claimed is:

1. A shopping cart immobilizing cradle device comprising:
(a) a sufficiently rigid unit of predetermined composition and shape;
(b) said unit having a bottom surface that is generally flat but not perfectly smooth;
(c) said unit having an inclined ramp of predetermined size and degree of slope;
(d) the base of said inclined ramp being designed to touch the surface upon which said device rests;
(e) said inclined ramp having perpendicular walls of predetermined height on both sides of its entire length;
(f) said perpendicular walls being further apart at said base of said inclined ramp and moving closer together towards the top of said inclined ramp by predetermined distancing;
(g) said top of said inclined ramp discharging into a cradle of predetermined size;
(h) said cradle having parallel and perpendicular walls on both sides;
(i) said cradle parallel and perpendicular walls being the same predetermined height as said inclined ramp walls;
(j) said parallel cradle walls being the same distance apart as said perpendicular walls at the very said top of said inclined ramp.

2. The shopping cart immobilizing cradle device of claim 1 wherein said unit has a permanently attached flexible tether of predetermined size and material for the purpose of device retrieval from a predetermined distance.
(a) said attached flexible tether having a means for attaching its loose end onto the front top rail of a shopping cart.

3. The shopping cart immobilizing cradle device of claim 1 wherein said unit has an indentation of predetermined size on the opposite side of said base of said inclined ramp for the purpose of front of the shoe placement to prevent said unit from sliding.
